(19) United States
(12) Patent Application Publication
(10) Pub. No.: US 2012/0087659 A1
(43) Pub. Date: Apr. 12, 2012

(54) Wavelength Aligning Multi-Channel Optical Transmitters

(76) Inventor: Douglas M. Gill, South Orange, NJ (US)

(21) Appl. No.: 12/945,550

(22) Filed: Nov. 12, 2010

Related U.S. Application Data
(60) Provisional application No. 61/390,876, filed on Oct. 7, 2010.
(60) Provisional application No. 61/390,837, filed on Oct. 7, 2010.
(60) Provisional application No. 61/390,840, filed on Oct. 7, 2010.
(60) Provisional application No. 61/390,798, filed on Oct. 7, 2010.

(51) Int. Cl. H04J 14/02

(52) U.S. Cl. 398/49

(57) ABSTRACT

An apparatus includes an array of N laser light sources, an array of N optical detectors, and a wavelength-selective optical router. The wavelength-selective optical router is configured to receive light emitted by the laser light sources and to route the light received from each laser light source to one of the optical detectors corresponding thereto. The apparatus is configured to adjust output wavelengths of the laser light sources based on light intensities measured by the optical detectors.

### BACKGROUND

1. Technical Field

The inventions relate to apparatus and methods for optical communication.

2. Discussion of the Related Art

This section introduces aspects that may be helpful to facilitating a better understanding of the inventions. Accordingly, the statements of this section are to be read in this light and are not to be understood as admissions about what is in the prior art or what is not in the prior art.

In a wavelength-division-multiplexed (WDM) optical communication system, separate data streams are typically carried on different wavelength channels. Wavelengths of individual wavelength channels typically lie on a preselected grid for which adjacent wavelength channels are typically separated by the same spacing. In such WDM optical communication systems, the optical transmitters are usually wavelength-locked to the wavelengths channels of the preselected grid. Such wavelength-locking enables the optical transmitters and receivers to communicate more predictably and enables wavelength-selective optical routing to be performed in a more predictable manner.

### BRIEF SUMMARY

Various embodiments provide optical transmitters configured to transmit over multiple wavelength channels whose wavelengths are substantially stabilized in the face of varying environmental conditions, e.g., temperature.

One embodiment of an apparatus includes an array of N laser light sources, an array of N optical detectors, and a wavelength-selective optical router. The wavelength-selective optical router is configured to receive light emitted by the laser light sources and to route the light received from each laser light source to one of the optical detectors corresponding thereto. The apparatus is configured to adjust output wavelengths of the laser light sources based on light intensities measured by the optical detectors.

In some embodiments of the apparatus, the apparatus may be configured to control each laser light source to output a data-modulated optical carrier in a different wavelength channel than the remainder of the laser light sources. In some such embodiments, the apparatus may further include an optical multiplexer connected to multiplex the data-modulated optical carriers output by the laser light sources. In some such embodiments, each laser light source may include a laser cavity with reflectors at different first and second ends thereof and is connected to transmit light through the first end to the optical multiplexer and is connected to transmit light through the second end to the wavelength-selective optical router. In other such embodiments, the wavelength-selective optical router may include the optical multiplexer and an optical demultiplexer serially connected thereto.

In some embodiments of any of the above apparatus, each optical detector may be configured to generate an electrical feedback signal that controls an output wavelength of the corresponding laser light source.

In some embodiments of any of the above apparatus, each optical detector may include a first light intensity detector connected to measure light in a first wavelength range and a second light intensity detector connected to measure light in a different second wavelength range, wherein the first and second wavelength ranges are mostly non-overlapping, e.g., overlapping less than 50% of their wavelength ranges and preferably less than 20% of those ranges or less than 10% of those ranges.

In some embodiments of any of the above apparatus, the apparatus may be an optical data transmitter.

One embodiment of a method includes driving laser light sources of an array, in parallel, to output corresponding data-modulated optical carriers and during performance of the driving, transmitting light emitted by the laser light sources to a wavelength-selective optical router. For each laser light source, the wavelength-selective optical router is configured to deliver part of the light in a different preselected transmission band corresponding to the each laser light source to an optical detector corresponding to the each laser light source. The method includes adjusting output wavelengths of the laser light sources based on intensities of the light received by the optical detectors during the transmitting such that the laser light sources output the data-modulated optical carriers substantially aligned in the different transmission bands.

In some embodiments of the above method, the method may further include, during the transmitting, delivering an electrical feedback signal from each optical detector to the corresponding laser light source to perform the adjusting the output wavelength thereof.

In some embodiments of any of the above methods, the transmitting may include delivering light in a first part of each preselected transmission band to a first light intensity detector of the corresponding optical detector to produce a measure of a light intensity of the first part of the same each preselected transmission band and may include delivering light in a disjoint second part of the same each preselected transmission band to a second light intensity detector of the same corresponding optical detector to produce a measure of a light intensity of the second part of the same each preselected transmission band.

In some special embodiments of any of the above methods, the method may further include optically multiplexing the data-modulated optical carriers output by the laser light sources.

In some such special embodiments of the above methods, the transmitting may also include performing the optical multiplexing and optically demultiplexing the optically multiplexed light to deliver the parts of the light in the preselected transmission hands to the corresponding optical detectors. The optically demultiplexing may include delivering light in a first part of each preselected transmission band to a first light intensity detector of the corresponding one of the optical detectors to produce a measure of a light intensity of the first part of the each preselected transmission band and may include delivering light: in a disjoint second part of the same each preselected transmission band to a second light intensity detector of the same corresponding one of the optical detectors to produce a measure of a light intensity of the second part of the same each preselected transmission band.

In other such special embodiments of the above methods, the optically multiplexing may include receiving light through first ends of the laser cavities of the laser light sources in the optical multiplexer and receiving light through different second ends of the laser cavities in a wavelength-selective optical router that performs the transmitting. In some such embodiments, during the transmitting, the method may also include, during the transmitting, delivering an electrical feedback signal from each optical detector to the corresponding laser light source to perform the adjusting the output wavelength thereof.

An embodiment of a second apparatus includes an array of one or more laser light sources, an array of one or more optical detectors, and an array of one or more free-space dispersive optical elements. Each free-space dispersive optical element is an optical grating or an optical prism. Each free-space dispersive optical element is configured to receive light emitted by a corresponding one of the one or more laser light sources and to route the received light to a corresponding one of the one or more optical detectors. The apparatus is configured to adjust the output wavelength of each laser light source based on a light intensity measured by the corresponding optical detector.

In some embodiments of the second apparatus, the array of one or more laser light sources may include more than one of the laser light sources, and the apparatus may be configured to control each laser light source to output a data-modulated optical carrier in a different wavelength channel than any other of the laser light sources.

In any of the above embodiments of the second apparatus, each optical detector may be configured to generate an electrical feedback signal that controls an output wavelength of the corresponding laser light source.

In any of the above embodiments of the second apparatus, each optical detector may include a first: light intensity detector connected to measure light in a first wavelength range and a second light intensity detector connected to measure light in a second wavelength range, the first and second wavelength ranges being mostly non-overlapping.

In some embodiments of the second apparatus, the array of one or more laser light sources may include more than one of the laser light sources, and the apparatus may further include an optical multiplexer connected to multiplex the data-modulated optical carriers output by the laser light sources. In some such embodiments, each laser light source may include a laser cavity with reflectors at different first and second ends thereof and may be connected to transmit light through the first end to the optical multiplexer and transmit light through the second end to the corresponding free-space dispersive optical element. In such embodiments, each optical detector may generate an electrical feedback signal that controls the output wavelength of the corresponding laser light source. In other such embodiments, each optical detector may include a first light intensity detector connected to measure light in a first wavelength range and a second light intensity detector connected to measure light in a second wavelength range, wherein the first and second wavelength ranges are mostly non overlapping wavelength ranges.

In any of the above embodiments of the second apparatus, the apparatus may include an optical data transmitter.

### BRIEF DESCRIPTION OF THE DRAWINGS

FIG. 1 is a block diagram schematically illustrating one embodiment of an optical transmitter;

FIG. 2A is a block diagram schematically illustrating a specific embodiment of an optical transmitter according to FIG. 1;

FIG. 2B is a block diagram schematically illustrating an alternate specific embodiment of an optical transmitter according to FIG. 1;

FIG. 3 schematically illustrates an alternate embodiment of an optical transmitter in which wavelength locking may be based on light emitted from backsides of lasers;

FIG. 3A schematically illustrates an N×2N planar optically integrated embodiment of the wavelength-selective optical router of FIG. 3;

FIG. 4 schematically illustrates another embodiment of an optical transmitter in which wavelength locking may be based on light emitted from backsides of lasers;

FIG. 5 schematically illustrates a specific analog embodiment for the individual optical detectors of FIGS. 1, 2A, 2B, and 3;

FIG. 6 schematically illustrates an example of light spectra that might be expected to be received at three wavelength-adjacent optical detectors according to FIGS. 1, 2A, 2B, and/or 3; and

FIG. 7 is a flow chart schematically illustrating an example of a method of wavelength locking, e.g., for use in the optical transmitters illustrated in FIGS. 1, 2A, 2B, 3, 3A, and/or 4.

In the Figures and text, like reference symbols indicate elements with similar or the same function and/or structure.

In the Figures, relative dimension(s) of some feature(s) may be exaggerated to more clearly illustrate the feature(s) and/or relation(s) to other feature(s) therein.

Herein, various embodiments are described more fully by the Figures and the Detailed Description of Illustrative Embodiments. Nevertheless, the inventions may be embodied in various forms and are not limited to the embodiments described in the Figures and the Detailed Description of Illustrative Embodiments.

### DETAILED DESCRIPTION OF ILLUSTRATIVE EMBODIMENTS

U.S. provisional applications 61/390,876; 61/390,837; 61/390,840; and 61/390,798, which were all filed on Oct. 7, 2010; U.S. application “FIBER-OPTIC ASSEMBLY FOR A WDM TRANSCEIVER”, which is being filed on Nov. 10, 2010, by David Neilson, Nagesh Basavanhally, and Mark Earnshaw (Docket No. 807934-US-NP); U.S. application “OPTO-ELECTRONIC ASSEMBLY FOR A LINE CARD”, which is being filed on Nov. 10, 2010, by Mark Earnshaw (Docket No. 807933-US-NP); U.S. application “OPTICAL TRANSMITTER WITH FLIP-CHIP MOUNTED LASER OR INTEGRATED ARRAYED WAVEGUIDE GRATING WAVELENGTH DIVISION MULTIPLEXER”, which is being filed on Nov. 10, 2010, by Mark Earnshaw and Flavio Pardo (Docket No. 807931-US-NP); U.S. application “THERMALLY CONTROLLED SEMICONDUCTOR OPTICAL WAVEGUIDE”, which is being filed on Nov. 10, 2010, by Mahmoud Rastas (Docket No. 808553-US-NP); and U.S. application “DIRECT LASER MODULATION”, which is being filed on Nov. 10, 2010, by David T. Nielson and Pietro Bernasconi (Docket No. 807932-US-NP); are all incorporated herein by reference in their entirety. One or more of the above applications may describe optical transmitter structures and/or optical receiver structures; methods of making optical receiver structures and/or optical transmitter structures; and/or methods of using optical receivers, optical transmitters, and components thereof that may be suitable for making and/or using embodiments described herein.

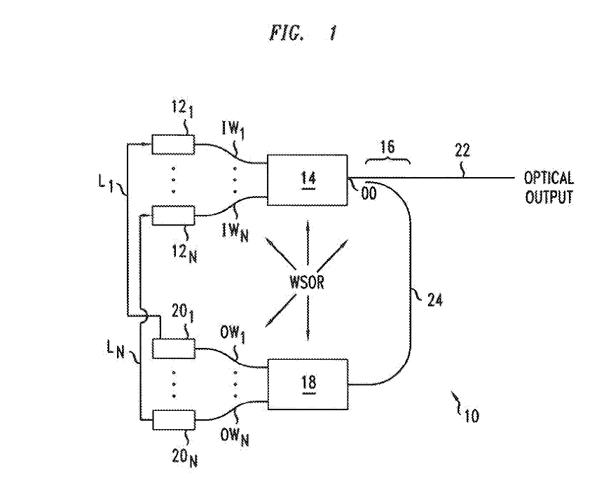

FIG. 1 schematically illustrates an example of an optical transmitter 10 that is configured to, in parallel, optically transmit data to an array of wavelength channels, e.g., approximately equally spaced wavelength-channels. The optical transmitter 10 includes an array of N laser light sources 12₁-12_{N}, a wavelength-selective optical router WSOR, and an array of N optical detectors 20₁-20_{N}. In various embodiments, the sizes, N, of the arrays of laser light sources 12₁-12_{N} and optical detectors 20₁-20_{N} are larger than 1, e.g., N≦10.

Each laser light source 12₁-12_{N} of the array can output an optical carrier, e.g., a digital data-modulated optical carrier, on a corresponding wavelength channel. The individual laser light sources 12₁-12_{N} may include, e.g., a conventional laser and electrical driver that directly modulates the corresponding laser to output a digital data-modulated optical carrier. Alternately, the individual laser light sources 12₁-12_{N} may include, e.g., a laser and a conventional external optical modulator configured to modulate a digital data stream onto a substantially unmodulated optical carrier output by the laser, i.e., an undithered or relatively slowly dithered optical carrier output by the laser.

In some embodiments, all of the N laser light sources 12₁-12_{N} are directly modulated lasers or are externally modulated lasers. In other embodiments, K laser light sources 12₁-12_{K} are externally modulated lasers, and the remaining (N-K) laser light sources 12_{K}-12_{N} are directly modulated lasers. Here, N>K>0.

Each laser light source 12₁-12_{N} may be operated to produce a modulated optical carrier in a corresponding preselected wavelength channel of a preselected grid. For example, the different preselected wavelength channels of the laser light sources 12₁-12_{N} may have center wavelengths that are aligned to within about 10 percent of inter-channel spacing to such a grid for wavelength-division multiplexed systems, as specified by the International Telecommunication Union (e.g., the “ITU-Grid”).

Each optical detector 20₁-20_{N} of the array corresponds to a different one of the laser light sources 12₁-12_{N}. In particular, individual optical detectors 20₁-20_{N} are typically optically connected to substantially only receive from the corresponding one of the laser light sources 12₁-12_{N}, e.g., up to inter-channel interference. The optical detectors 20₁-20_{N} provide feedback signals for controlling output wavelengths of the laser light sources 12₁-12_{N}. In some embodiments, each of the optical detectors 20₁-20_{N} may be electrically connected, e.g., by a corresponding set of one or more electrical lines L₁-L_{N} to the corresponding one of the laser light sources 12₁-12_{N}. Then, the electrical lines L₁-L_{N} may provide analog electrical feedback signals that control and/or adjust the output wavelengths of the corresponding laser light sources 12₁-12_{N}. Such direct analog electrical feedback may provide a low-overhead system for wavelength locking the laser light sources 12₁-12_{N} to their corresponding preselected wavelength channels.

Herein, a light detector is referred to as being connected to measure light over a wavelength range that is the full width at half maximum of the optical filter connecting the light detector to a light source providing the light for measurement by the light detector.

The wavelength-selective optical router WSOR provides wavelength-selective routing of part of the light from the laser light sources 12₁-12_{N} to their corresponding optical detectors 20₁-20_{N}. In particular, the wavelength-selective optical router WSOR is configured to route part of the light in the preselected wavelength of each laser light source 12ₖ to the corresponding optical detector 20ₖ. With respect to each laser light source 12ₖ, the wavelength-selective optical router WSOR optically filters light therefrom so that substantially only that part of the light in the corresponding preselected wavelength channel is delivered to the optical detector 20ₖ.

Thus, the optical characteristics or the wavelength-selective optical router WSOR determine the set of N preselected wavelength channels for the N laser light sources 12₁-12_{N}. To ensure temperature stability of the optical transmitter 10, some embodiments of the wavelength-selective optical router WSOR are constructed to operate athermally. Then, the set of N preselected wavelength channels will not substantially vary when temperature variations occur in the optical transmitter 10. To achieve such athermal operation, the wavelength-selective optical router WSOR may incorporate athermalized AWGs. An athermalized AWG may be formed, e.g., of optical waveguides whose optical cores are made of series of alternating segments. In each series, the alternating segments series are made of materials whose refractive indexes have thermal coefficients of opposite sign, e.g., a series of silicone segments alternated with silicon segments. Examples of athermalized AWGs may be described, e.g., in U.S. patent application Ser. No. 12/611,187, which was filed on Nov. 3, 2009 and is incorporated herein by reference in its entirety. Alternately, to achieve athermal operation, the temperature of the wavelength-selective optical router WSOR may be stabilized during operation. For example, the absolute output wavelength of one of the laser light sources 12_{K} may be used to monitor the temperature of the wavelength-selective optical router WSOR if the output wavelength of the one of the laser light sources 12_{K} is locked based on electric feedback from the corresponding optical detector 20_{K}. In such a situation, the output wavelength shift of the one of the laser light sources 12_{K} is attributable to changes in optical characteristics of the wavelength-selective optical router WSOR. A measured shift in the temperature and/or optical characteristics of the wavelength-selective optical router WSOR may be compensated by heating or cooling the wavelength-selective optical router WSOR. Example ways to monitor the absolute output wavelength of one of the laser light sources 12₁-12_{N}, are, e.g., disclosed in the above-incorporated U.S. provisional application 61/390,876, filed on Oct. 7, 2010 and the above-incorporated U.S. patent application “DIRECT LASER MODULATION” by David T. Nielson and Pietro Bernasconi concurrently with this application. Alternately, a thermistor can be used monitor the temperature of either the wavelength-selective optical router WSOR or a temperature-sensitive component thereof, e.g., AWG(s).

FIG. 1 illustrates an optical transmitter 10 in which the wavelength-selective optical router WSOR both wavelength-selectively routes filtered light to the optical detectors 12₁-12_{N} and routes wavelength-multiplexed light to an optical output of the optical transmitter 10. In the optical transmitter 10, the wavelength-selective optical router WSOR includes an optical multiplexer 14, an optical tap 16, and an optical demultiplexer 18.

The optical multiplexer 14 is optically connected to receive light from each laser light source 12₁-12_{N} via a corresponding input optical waveguide IN₁-IW_{N} and to produce, at an optical output (OO) an optically multiplexed light beam from the received light in different wavelength channels. At the optical output OO, the optically multiplexed light beam is received by an optical waveguide 22 that guides most of the multiplexed light beam towards the optical output of the optical transmitter 10. The optical multiplexer 14 may be, e.g., any conventional optical multiplexer, e.g., an integrated arrayed waveguide grating (AWG) optical multiplexer or a free-space optical grating-based optical multiplexer for which optical waveguides IW₁-IW_{N} may be present or absent.

The optical tap 16 redirects a portion of the optically multiplexed light beam output by the optical multiplexer 14, i.e., in a substantially wavelength-independent manner. A filtered part of the redirected portion is delivered to the optical detectors 20₁-20_{N}, which use said filtered part to generate electrical feedback signals indicative of changes in the output wavelengths of the laser light sources 12₁-12_{N}. The generated electrical feedback signals are used to control and/or adjust the output wavelengths of the laser light sources 12₁-12_{N}. The optical tap 16 typically redirects only a small portion of the optically multiplexed light beam from the optical multiplexer 14, e.g., less than 10 percent, preferably less than 5 percent, or more preferably less than 1 percent of the optical intensity in the optically multiplexed light beam is redirected. For that reason, a much larger portion of the light from the optical multiplexer 14 is delivered to the optical output of the optical transmitter 10. The optical tap 16 may be, e.g., any conventional optical tap or optical power or polarization splitter, e.g., an optical splitter configured to transmit a much larger portion of the received optical power to the optical output of the optical transmitter 10 than to the optical waveguide 24.

The optical demultiplexer 18 receives the redirected portion of the multiplexed light from the optical tap 16 via an optical waveguide 24 and optically demultiplexes the received portion into N preselected wavelength channels that correspond in a one-to-one manner to the N laser light sources 12₁-12_{N}. For each of the preselected wavelength channels, a part of the demultiplexed light in a corresponding preselected wavelength channel is delivered the corresponding one of the optical detectors 20₁-20_{N} via single or paired output waveguides OW₁-OW_{N} of the optical demultiplexer 18. The optical demultiplexer 18 may be, e.g., any conventional optical demultiplexer, e.g., an integrated arrayed waveguide grating (AWG) optical demultiplexer or a free-space optical grating-based device in which the single or paired optical waveguides OW₁-OW_{N} and/or the optical waveguide 24 may be present or absent.

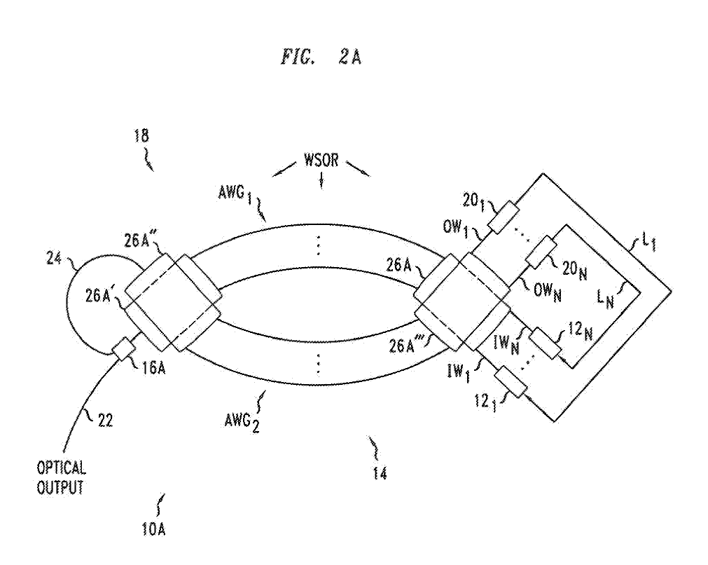

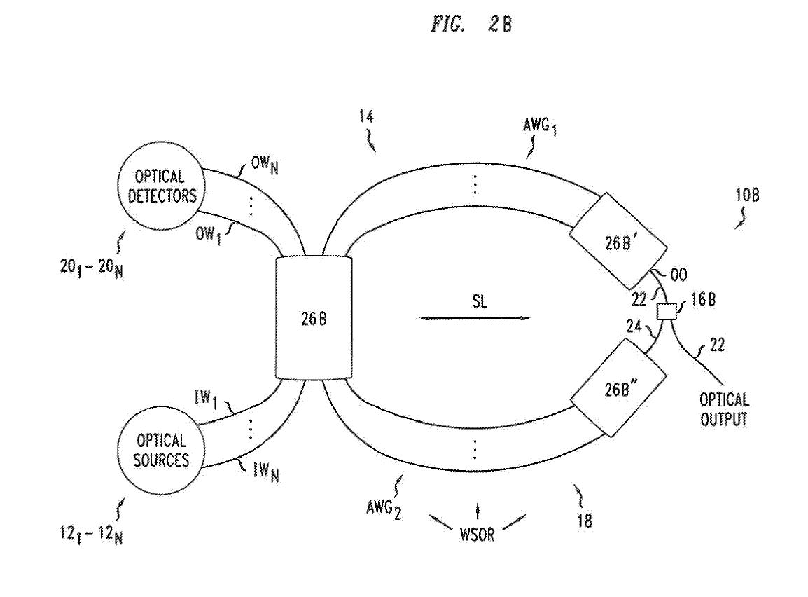

FIG. 2A schematically illustrates a planar integrated embodiment 10A of the optical transmitter 10 illustrated in FIG. 1. In some embodiments, the optical transmitter 10A may be hybrid integrated on two or more different material substrates for wavelength-selective optical router WSOR, the laser optical sources 12₁-12_{N}, and/or the optical detectors 20₁-20_{N}. For example, some suitable methods for hybrid integration may be described in concurrently filed U.S. application “OPTICAL TRANSMITTER WITH FLIP-CHIP MOUNTED LASER OR INTEGRATED ARRAYED WAVEGUIDE GRATING WAVELENGTH DIVISION MULTIPLEXER” by Mark Earnshaw and Flavio Pardo and/or in U.S. provisional application 61/390,798, filed on Oct. 7, 2010, which are both incorporated by reference herein in their entirety.

In the optical transmitter 10A, the optical multiplexer 14 includes planar free-space optical regions 26A, 26A′ and an arrayed optical waveguide grating AWG₁. In the optical transmitter 10A, the optical tap 16 may include a 1×2 optical power splitter 16A with asymmetric power splitting that directs most of the received optical power to the output optical waveguide 22, i.e., towards the optical output of the optical transmitter 10A. In the optical transmitter WA, the optical demultiplexer 18 includes planar free-space optical regions 26A″, 26A′″ and an arrayed optical waveguide grating AWG). In some embodiments, the planar free-space optical regions 26A″ and 26A′″ are vertically stacked over and/or under the respective free-space optical regions 26A and 26B to reduce the lateral footprint of the optical transmitter 10A. In other embodiments, components of the optical multiplexer 14 and the optical demultiplexer 18 are not vertically stacked.

FIG. 2B schematically illustrates an alternate specific embodiment of a planar optically integrated embodiment 10B of the optical transmitter 10 of FIG. 1. In some embodiments, the optical transmitter 10B may be hybrid integrated on two or more different material substrates for wavelength-selective optical router WSOR, the laser optical sources 12₁-12_{N}, and/or the optical detectors 20₁-20_{N}, e.g., as already described with respect to the optical transmitter 10A of FIG. 2A.

In the optical transmitter 108, the optical multiplexer 14 includes planar free-space optical regions 26B and 26W and the arrayed optical waveguide grating AWG₁. In the optical transmitter 10B, the optical tap 16 may include a 1×2 optical power splitter 168 with asymmetric power splitting, i.e., to provide most of the received optical power to the segment of the output optical waveguide 22 directed towards the optical output of the optical transmitter 10B. In the optical transmitter 10B, the optical demultiplexer 18 includes the planar free-space optical regions 26B and 26B″ and an arrayed optical waveguide grating AWG₂. That is, the optical multiplexer 14 and the optical demultiplexer 18 share the free-space optical region 26B. For example, the layout of optical connections in the optical demultiplexer 18 may be an approximate mirror image across, i.e., across the symmetry line SL, of the layout of optical connections in the optical multiplexer 14.

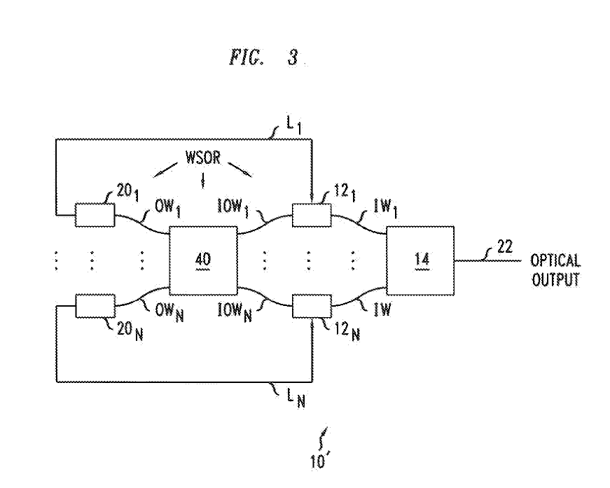

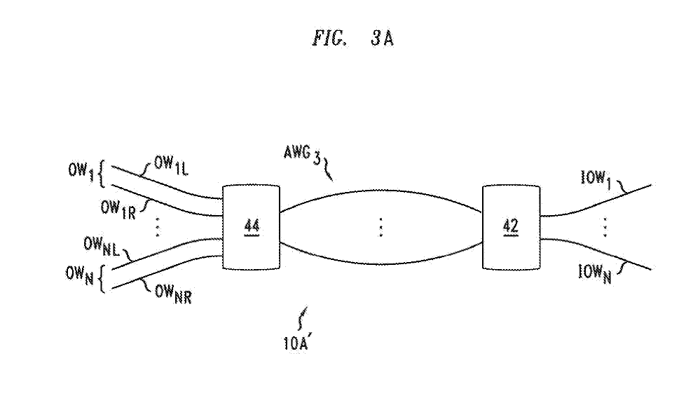

FIG. 3 illustrates an alternate embodiment for an optical transmitter 10′. The optical transmitter 10′ includes an array of N laser light sources 12₁-12_{N}, an optical multiplexer 14, a wavelength-selective optical router WSOR, an array of N optical detectors 20₁-20_{N}, and an output optical waveguide 22.

The wavelength-selective optical router WSOR optically couples, in parallel, the N laser light sources 12₁-12_{N} to the corresponding N optical detectors 20₁-20_{N} without transmitting wavelength-channel multiplexed light towards the optical output of the optical transmitter 10′. In particular, the wavelength-selective optical router WSOR receives light from back surfaces of the lasers of laser light sources 12₁-12_{N}. That is, the wavelength-selective optical router WSOR receives light leaking from back surfaces of the transmitter's lasers for use in optical monitoring used for wavelength locking. In contrast, the optical multiplexer 14 receives light from the front surfaces of the lasers of the laser light sources 12₁ 12_{N}, i.e., for transmission to the optical output of the optical transmitter 10′.

The laser light sources 12₁-12_{N}, optical multiplexer 14, optical detectors 20₁-20_{N}, and output optical waveguide 22 may be constructed as already described with respect to optical transmitters 10, 10A, and 10B of FIGS. 1, 2A, and 2B. For example, the optical detectors 20₁-20_{N} may provide electrical feedback currents via electrical lines L₁-L_{N} to maintain center output wavelengths of the laser light sources 12₁-12_{N} at the corresponding pre-selected center wavelengths on a preset grid.

FIG. 3A schematically illustrates a passive integrated optical embodiment 10A′ of the wavelength-selective optical router WSOR of FIG. 3. The passive, integrated, wavelength-selective optical router 10A′ selectively routes light from individual ones of the laser light sources 12₁-12_{N}, in parallel, to corresponding individual ones of the optical detectors 20₁-20_{N}. The N×2N passive, integrated, wavelength-selective optical router 10A′ includes an arrayed waveguide grating AWG₃, a first planar free-space optical region 42, a second planar free-space optical region 44, N input optical waveguides IOW₁-IOW_{N}, and N single or paned output optical waveguides OW₁-OW_{N}. The first planar free-space optical region 42 has a first surface on which are located input ends of optical waveguides of the AWG AWG₃ and has a second surface on which output ends of the N input optical waveguides IOW₁-IOW_{N} are located. The second planar free-space optical region 44 has a first surface on which are located output ends of the optical waveguides of the AWG AWG₃ and has a second surface on which input ends of the N single or paired output optical waveguides OW₁-OW_{N} are located.

The passive, integrated, wavelength-selective optical router 10A′ may be configured to direct light in the left and right halves of a preselected wavelength band to separate detectors in each of the optical detectors 20₁-20_{N}, e.g., as illustrated in FIG. 3A. In such embodiments, the wavelength-selective optical router 10A′ is an N×2N wavelength-selective optical coupler, and each single or paired output optical waveguides OW₁, . . . , OW_{N} is a pair of optical waveguides (ow_{1L}, . . . , ow_{1R}), . . . , (ow_{NL}, ow_{NR}). Then, each optical waveguide ow_{kL} delivers light in the left half of the k-th preselected wavelength channel to a first light intensity detector of the k-th optical detector 20ₖ, and each optical waveguide ow_{kR} delivers light in the right half of the k-th preselected wavelength channel to a separate second light intensity detector of the k-th optical detector 20ₖ.

In FIGS. 1 and 3, the various wavelength-selective optical routers WSOR and/or the optical multiplexer 14 may also be constructed as free-space optical devices. In such cases, the wavelength-selective optical routers may be conventional bulk diffraction gratings, and some or all of the single or paired output optical waveguides OW₁-OW_{N} and/or input optical waveguides IW₁-IW_{N} and/or IOW₁-IOW_{N} may be optional.

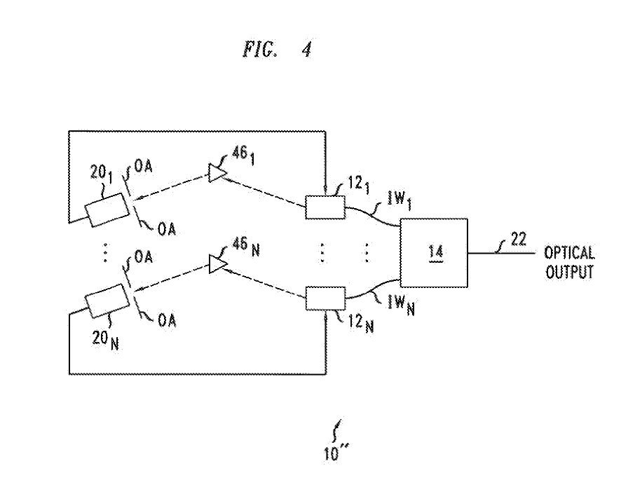

FIG. 4 illustrates a further embodiment of an optical transmitter 10″ in which output wavelength control and/or locking is based on light emitted from backsides of lasers. In particular, the optical transmitter 10″ includes the optical multiplexer 14, an array of N laser light source(s) 12₁-12_{N}, input optical waveguides IW₁-IW_{N}, output optical waveguide 22, an array of N light detectors(s) 20₁-20_{N}, and an array of N free-space dispersive optical element(s) 46₁-46_{N}. Here, N is a positive integer that is greater than or equal to one.

The optical transmitter 10″ is similar to the optical transmitter 10″ of FIG. 3. In each optical transmitter 10′, 10″, elements with the same reference number function in the same or a similar manner, e.g., as described with respect to FIG. 3.

The optical transmitter 10″ includes array of N dispersive optical element(s) 46₁-46_{N}, wherein each such element is a separate optical grating or optical prism. Each dispersive optical element 46ₖ is placed and oriented to direct a light beam (indicated by dashed lines) from a backside of the single corresponding laser light source 12_{K} to the single corresponding light detector 20_{K}. The backside of each laser light source 12_{K} may include an optical lens (not shown) that collimates light emitted there from into a light beam such that the emitted light is substantially only directed to the corresponding dispersive optical element 46ₖ and is subsequently substantially only directed to the corresponding light detector 20_{K}. In addition, each light detector 20_{K} includes an optical aperture OA so that the light intensity measured by the corresponding light detector 20_{K} depends significantly on the center output wavelength of the corresponding laser light source 12_{K}. Thus, each optical aperture OA and corresponding dispersive optical element 46ₖ together function as a wavelength-selective optical filter. Indeed, in embodiments for which N is greater than one, the array of N dispersive optical elements 46₁-46_{N} functions as a free-space wavelength-selective optical router WSOR, e.g., as described with respect to the other optical transmitters of FIGS. 1, 2A, 2B, 3, and 3B. Each light detector 20_{K} generates electrical signals indicating measured light intensities that are fedback to control, adjust, and/or lock the center output wavelength of the corresponding laser light source 12_{K}.

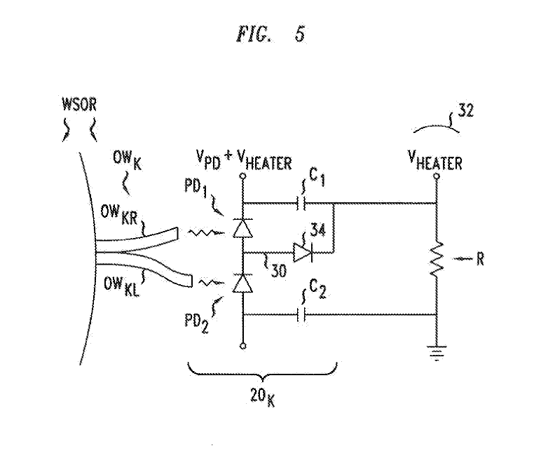

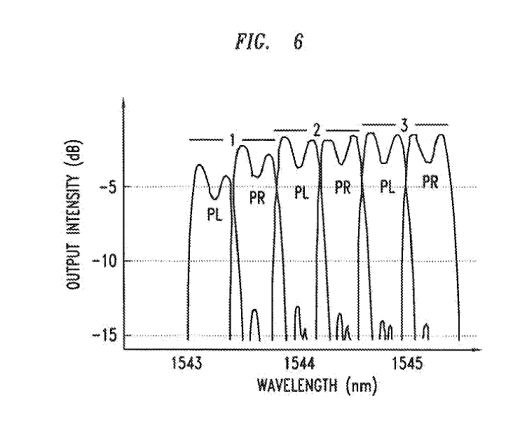

FIGS. 5 and 6 schematically illustrate how an example of the array of N optical detectors 20₁-20_{N} may be configured to operate in embodiments of the optical transmitter(s) 10, 10A, 10B, 10′, 10A′, 10″ of FIGS. 1, 2A, 2B, 3, 3A, and/or 4, e.g., in embodiments where the laser light sources 12₁-12_{N} undergo direct laser modulation. Direct laser modulation typically causes each directly modulated laser of the array to output light of a first amplitude in response to receiving digital data of logic 0 and to output light of a different second amplitude in response to receiving digital data value of logic 1. Then, the output optical spectrum of the array, each wavelength channel will have one spectral peak P₁ centered at the wavelength corresponding to the data value of logic 1 and will have another spectral peak P₀ centered at the slightly different wavelength corresponding to the data value of logic 0.

FIG. 6 schematically illustrates an example of expected time-averaged, light spectra that might be received at the optical detectors 20₁, 20₂, 20₃ when each of the corresponding laser light sources 12₁, 12₂, 12₃ is directly laser modulated to output a binary amplitude-modulated, optical carrier. FIG. 6 superimposes six plots of intensity in decibels (dB) versus wavelength in nanonmeters (nm) for three pairs of peaks PL and PR without adding the intensities of different ones of the peaks. For each laser light source 12₁-12₃, the time-averaged, output light spectra includes a left peak PL for light transmitting one binary data value and a right peak PR for light transmitting the other binary data value. Each individual peak, i.e., a PL peak or a PR peak, has a pair of smaller sub-peaks thereon, because the spectra of FIG. 6 are for transmission through a flat-top AWG-version of the wavelength-selective optical router WSOR. FIG. 6 also indicates by thick horizontal lines the preselected wavelength-channels 1, 2, and 3 corresponding to the laser light sources 12₁, 12₂, 12₃.

Each of the laser light sources 12₁-12₃ is typically expected to transmit about equal amounts of the two digital data values when averaged over long enough time periods, e.g., over periods of a few milli-seconds, and, in some embodiments, each laser light source 12₁-12₃ is also expected to transmit about the same time-averaged output power for each of the two digital data values. In such embodiments, the left and right peaks PL, PR of a single one of the preselected wavelength channels would typically have about the same time-averaged optical power when the center wavelength of the corresponding laser light source 12₁-12₃ is appropriately aligned in the corresponding preselected wavelength channel. Then, a difference between the time-averaged optical powers in the left and right peaks PL, PR of the same preselected wavelength channel is often indicative of a mis-alignment of the center output wavelength of the laser light source 12₁-12₃ corresponding to that preselected wavelength channel. For example, in FIG. 6, the time-averaged optical power of the left peak PL in the preselected wavelength channel 1 visually seems to be lower than the time-averaged optical power of the right peak PR in the same preselected wavelength channel 1 thereby indicating that a center output wavelength of the corresponding laser light source 12₁ is likely to be too long. Also, in FIG. 6, the time-averaged optical powers of the left and right peaks PL, PR of the same preselected wavelength channels visually seem to be about equal in the preselected wavelength channels 2-3 thereby indicating that the center output wavelength of the corresponding laser light sources 12₂-12₃ are likely to be properly aligned.

In other embodiments, each laser light source 12₁-12₃ is still expected to transmit about equal amounts of the two digital data values when averaged over long enough time periods, e.g., a few milli-seconds, but each laser light source 12₁-12₃ is also expected to transmit different time averaged output powers for the two different digital data values. In such embodiments, the relative powers in the left and right peaks PL, PR of a single preselected wavelength channel 1-3 would typically still be indicative of whether the center output wavelength of the corresponding laser light source 12₁-12₃ is appropriately aligned in that preselected wavelength channel 1-3. For example, the relative power difference may be substantially independent of the laser light sources 12₁-12₃ when properly aligned. Then, if the measured power difference in channel 1, e.g., differs from the measured power differences in the remaining channels 2-3 and the measured power differences of the remaining channels 2-3 are equal, the center output wavelength of the laser light source 12₁ would typically be mis-aligned. Thus, in these other embodiments, differences between the powers in the right and left peaks PR, PL of the various preselected wavelength channels 1-3 are typically still indicative of the alignments of the center output wavelengths of the individual laser light sources 12₁-12₃. Indeed, the optical transmitter may include control circuitry that accounts for the preselected values of the measured relative power differences when the laser light sources 12₁-12₃ are properly aligned to enable suitable estimations the positions of their center output wavelengths.

Thus, in the various embodiments, the difference between:
a time-average of the optical power received at the corresponding optical detector 20₁-20₃, in the left half of the wavelength range for a preselected wavelength-channel 1-3, and
the same time-average of the optical power received at the corresponding optical detector 20₁-20₃, in the right half of the wavelength range for the same preselected wavelength-channel 1-3,
   is a measure that is indicative of the alignment of the center output wavelength of the corresponding laser light source 12₁-12₃. If the about difference is greater than a preselected value, e.g., 0 in some embodiments, the center output wavelength of the corresponding laser light source 12₁-12₃ is typically too much to the left in the wavelength band of the corresponding preselected wavelength channel 1-3. If the difference is less than the same preselected value, e.g., 0 in some embodiments, the center output wavelength of the corresponding laser light source 12₁-12₃ is typically too much to the right in the wavelength band of the corresponding preselected wavelength channel 1-3. For these reasons, the difference between approximately DC optical powers received at separate light intensity detectors for the left and right half bands of a preselected wavelength-channel often can be used as feedback signals for locking the center output wavelengths of the laser light sources transmitting light to those preselected wavelength channels 1-3.

FIG. 5 schematically illustrates a specific embodiment 20ₖ for some or all of the individual optical detectors 20ₖ of FIGS. 1, 2A, 2B, and 3, i.e., for k in [1, N]. The optical detector 20ₖ is useful, e.g., when the corresponding laser light source 12ₖ is directly laser modulated to output a two-state amplitude modulated optical carrier, and the wavelength-selective optical router WSOR forms an N×2N wavelength-selective optical coupler. The optical detector 20ₖ includes a series-connected matched pair of photo-diodes PD₁, PD₂, i.e., light intensity detectors, and an output electrical tap 30 located between the photo-diodes PD₁, PD₂. The photo-diodes PD₁, PD₂ may be ordinary photo-diodes or avalanche photo-diodes. The output electrical tap 30 electrically connects to an environmental controller 32 for the corresponding laser light source 12ₖ. The environmental controller 32 may include, e.g., a resistive heater R that is able to separately change the output wavelength of the laser of the laser light source 12ₖ by changing the temperature of the laser's optical cavity. The output electrical tap 30 may optionally include an electronic amplifier 34. The photo-diodes PD₁, PD₂ are otherwise electrically isolated from the environmental controller 32 by capacitors C₁, C₂.

The pair of matched photo-diodes PD₁, PD₂ may be connected to form a differential configuration. For example, the matched pair may deliver a current to resistive heater R for the corresponding laser light source 12ₖ when the optically generated electrical current from the photo-diode PD₂ is larger than the optically generated electrical current from the photo-diode PD₁. In such configurations, the matched pair also withdraws a current from the resistive heater R for the corresponding laser light source 12ₖ when the optically generated electrical current from the photo-diode PD₁ is larger than the optically generated electrical current from the photo-diode PD₂. In such a configuration, the matched pair automatically increases the heater current to and the temperature of the corresponding laser light source 12ₖ when the photo-diode PD₂ is exposed to a higher light intensity than the photo-diode PD₁ and decreases the heater current to and the temperature of the corresponding laser light source 12ₖ when the photo-diode PD₁ is exposed to a higher light intensity than the photo-diode PD₂.

Thus, the optical detector 20ₖ of FIG. 5 is able to maintain optical wavelength locking of the corresponding laser light source 12ₖ via a direct analog electric feedback current rather than based on complex processing of optical measurements in a digital data processor. In particular, locking the spacings between the preselected wavelength channels may not require digital data processing. Nevertheless, fixing the absolute center wavelength of one of the one of the laser light sources 12₁-12_{N} may involve some digital data processing.

Optically, such a differential configuration may involve coupling the matched pair of photo-diodes PD₁, PD₂ to the optical demultiplexer 18 by a pair OWₖ of optical waveguides ow_{kR}, ow_{kL}. The pair OWₖ includes an optical waveguide ow_{kR} delivering the photo-diode PD₂ light in the right half of the preselected wavelength channel corresponding to the laser light source 12ₖ and an optical waveguide ow_{kL} delivering to the other photo-diode PD₁ light in the left half of the selected wavelength channel corresponding to the laser light source 12ₖ. In the embodiment of the optical demultiplexer 18 of FIGS. 2A and 2B and the wavelength-selective optical router 10A′ of FIG. 3A, the optical waveguides ow_{kL} and ow_{kR} may have input ends at neighboring locations on the same surface of the free-space optical region 26A′″, 26B, 44, so that these ends receive light from separate wavelength halves of the k-th preselected wavelength channel, which corresponds to the k-th laser light source 12ₖ.

FIG. 5 also illustrates a construction for the individual optical detectors 20₁-20_{N} that may also be used in other embodiments of the optical transmitters 10, 10A, 10B, 10′, 10A′, and 10″ of FIGS. 1, 2A, 2B, 3, 3A, and 4. For example, the construction may also be used when the individual laser light sources 12₁-12_{N}, are externally modulated. In such embodiments, the difference between the light intensity received by the photo-diode PD₁ and the photo-diode Pa) of the k-th optical detector 20ₖ still depends on the center wavelength of the k-th laser light source 12ₖ, e.g., the intensity difference may vanish when the center wavelength is properly aligned in the corresponding preselected wavelength channel.

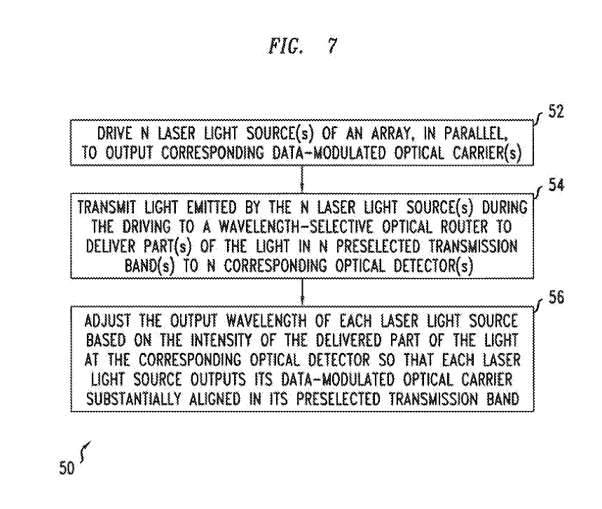

FIG. 7 schematically illustrates a method 50 of operating an array of one or more laser light sources, e.g., in the optical transmitters 10, 10A, 10B, 10′, 10A′, and/or 10″ of FIGS. 1, 2A, 2B, 3, 3A, and/or 4.

The method 50 includes driving N laser light source(s) of the array, in parallel, to output N corresponding data-modulated optical carrier(s), e.g., from the laser light sources 12₁-12_{N} (step 52). Here, the positive integer N is greater than or equal to one.

The method 50 includes transmitting light emitted by the N laser light source(s) during the driving of step 52 to a wavelength-selective optical router to deliver part(s) of the light in N different preselected transmission wavelength-band(s) to N optical detector(s), e.g., the optical detectors 20₁-20_{N} (step 54). Each optical detector corresponds to a different preselected transmission wavelength-band and to one of the N laser light source(s). The delivery of the light emitted by the laser light source(s) may be performed, in parallel, e.g., by the wavelength-selective optical routers WSOR illustrated in FIGS. 1, 2A, 2B, 3, 3A, and 4.

The method 50 includes adjusting the output wavelength(s) of the N laser light source(s) based on the intensity or intensities of the delivered part(s) of the light received at the N optical detector(s) such that each laser light source outputs a data-modulated optical carrier substantially aligned in a corresponding preselected transmission wavelength-band (step 56). Each laser light source has a preselected transmission wavelength-band that differs from the preselected transmission wavelength-hand corresponding to any others of the N laser light source(s). The adjusting step may be performed by a single centralized controller of the laser light source(s) or by individual controller(s), e.g., individual analog controller 32 as illustrated in FIG. 6. When N is larger than one, substantial alignment of the data-modulated optical carriers typically implies that center wavelengths of the data-modulated carriers are aligned with the wavelength-centers of the corresponding preselected transmission wavelength-bands to within an error of 25 percent or less of the average spacing between the preselected transmission wavelength-bands and preferably to within an error of 10 percent or less of the average spacing between the preselected transmission wavelength-bands.

Some embodiments of the method 50 may further include delivering an electrical feedback signal from each optical detector to the corresponding laser light source, i.e., during the transmitting step 54, to perform the adjusting the output wavelength thereof in the step 56.

In any of the embodiments of the method 50, the transmitting step 54 may include delivering light in a short-wavelength part of each preselected transmission wavelength-band to a first light intensity detector of the corresponding optical detector to produce a measure of a light intensity of the first part same preselected transmission wavelength-band and may further include delivering light in a disjoint high-wavelength part of the same preselected transmission wavelength-band to a separate second light intensity detector of the same optical detector to produce a measure of a light intensity of the second part of the same preselected transmission wavelength-band. For example, the configuration of the optical detector 20ₖ in FIG. 6 illustrates such an embodiment.

In embodiments of the method 50, for which N is greater than one, the method may further include optically multiplexing the data-modulated optical carriers output by the laser light sources, e.g., in the optical multiplexer 14. In some such embodiments, the transmitting may include performing the optical multiplexing and then, optically demultiplexing the optically multiplexed light, e.g., in the optical demultiplexer 18, to deliver the parts of the light in preselected transmission wavelength-bands to the optical detectors. The optically demultiplexing may include, e.g., delivering light in a shorter-wavelength part of each preselected transmission wavelength-band to a first light intensity detector of the corresponding optical detector to produce a measure of a light intensity of the short-wavelength part of the wavelength-band and may include delivering light in a disjoint long-wavelength part of the same preselected transmission wavelength-band to a second light intensity detector of the same optical detector to produce a measure of a light intensity of the long-wavelength part of the same wavelength-band, e.g., as illustrated in FIG. 6. In other such embodiments, the optically multiplexing includes receiving light through first ends of the laser cavities of the laser light sources in the optical multiplexer, e.g., the optical multiplexer 14 of FIG. 3, and receiving light through different second ends of the laser cavities in a wavelength-selective optical router that performs the transmitting, e.g., the wavelength-selective optical router WSOR of FIG. 3. In some such embodiments, during the transmitting, the method includes delivering an electrical feedback signal from each optical detector to the corresponding laser light source to perform the adjusting the output wavelength thereof, e.g., via the electrical lines L₁-L_{N}.

From the disclosure, drawings, and claims, other embodiments of the invention will be apparent to those skilled in the art.

What is claimed is:

1. An apparatus comprising:
an array of laser light sources;
an array of N optical detectors;
a wavelength-selective optical router configured to receive light emitted by the laser light sources and to route the light received from each laser light source to one of the optical detectors corresponding thereto; and
wherein the apparatus is configured to adjust output wavelengths of the laser light sources based on light intensities measured by the optical detectors.

2. The apparatus of claim 1, wherein the apparatus is configured to control each laser light source to output a data-modulated optical carrier in a different wavelength channel than the remainder of the laser light sources.

3. The apparatus of claim 1, wherein each optical detector is configured to generate an electrical feedback signal that controls an output wavelength of the corresponding laser light source.

4. The apparatus of claim 3, wherein each optical detector includes a first light intensity detector connected to measure light in a first wavelength range and a second light intensity detector connected to measure light in a second wavelength range, the first and second wavelength ranges being mostly non-overlapping.

5. The apparatus of claim 2, further comprising an optical multiplexer connected to multiplex the data-modulated optical carriers output by the laser light sources.

6. The apparatus of claim 5, wherein each laser light source includes a laser cavity with reflectors at different first and second ends thereof and is connected to transmit light through the first end to the optical multiplexer and transmit light through the second end to the wavelength-selective optical router.

7. The apparatus of claim 6, wherein each optical detector generates an electrical feedback signal that controls the output wavelength of the corresponding one of the laser light sources.

8. The apparatus of claim 6, wherein each optical detector includes a first light intensity detector connected to measure light in a first wavelength range and a second light intensity detector connected to measure light in a second wavelength range, the first and second wavelength ranges being mostly non-overlapping wavelength ranges.

9. The apparatus of claim 5, wherein the wavelength-selective optical router comprises the optical multiplexer and an optical demultiplexer serially connected thereto.

10. The apparatus of claim 9, wherein each optical detector generates an electrical feedback signal that controls the output wavelength of the corresponding one of the laser light sources.

11. The apparatus of claim 9, wherein each optical detector includes a first light intensity detector connected to measure light in a first wavelength range and a second light intensity detector connected to measure light in a second wavelength range, the first and second wavelength ranges being mostly non-overlapping wavelength ranges.

12. The apparatus of claim 2, wherein the apparatus is an optical data transmitter.

13. A method, comprising:
in parallel, driving laser light sources of an array to output corresponding data-modulated optical carriers;
during the driving, transmitting light emitted by the laser light sources to a wavelength-selective optical router, for each laser light source, the wavelength-selective optical router being configured to deliver a part of the light in a different transmission band corresponding to the each laser light source to an optical detector corresponding to the each laser light source; and
adjusting output wavelengths of the laser light sources based on intensities of the light received by the optical detectors during the transmitting such that the laser light sources output the data-modulated optical carriers substantially aligned in the different transmission bands.

14. The method of claim 13, further comprising during the transmitting, delivering an electrical feedback signal from each optical detector to the corresponding laser light source to perform the adjusting the output wavelength thereof.

15. The method of claim 13, wherein the transmitting includes delivering light in a first part of each preselected transmission band to a first light intensity detector of the corresponding optical detector to produce a measure of a light intensity of the first part of the same each preselected transmission band and may include delivering light in a disjoint second part of the same each preselected transmission band to a second light intensity detector of the same corresponding optical detector to produce a measure of a light intensity of the second part of the same each preselected transmission band.

16. The method of claim 13, further comprising optically multiplexing the data-modulated optical carriers output by the laser light sources.

17. The method of claim 16, wherein the transmitting includes performing the optical multiplexing and optically demultiplexing the optically multiplexed light to deliver the parts of the light in the preselected transmission bands to the corresponding optical detectors.

18. The method of claim 17, wherein the optically demultiplexing includes delivering light in a first part of each preselected transmission band to a first light intensity detector of the corresponding one of the optical detectors to produce a measure of a light intensity of the first part of the each preselected transmission band and includes delivering light in a disjoint second part of the each preselected transmission band to a second light intensity detector of the corresponding one of the optical detectors to produce a measure of a light intensity of the second part of the each preselected transmission band.

19. The method of claim 16, wherein the optically multiplexing includes receiving light through first ends of the laser cavities of the laser light sources in the optical multiplexer and receiving light through different second ends of the laser cavities in the wavelength-selective optical router that performs the transmitting.

20. The method of claim 17, further comprising during the transmitting, delivering an electrical feedback signal from each optical detector to the corresponding laser light source to perform the adjusting the output wavelength thereof.

21. An apparatus comprising:
an array of one or more laser light sources;
an array of one or more optical detectors;
an array of one or more free-space dispersive optical elements, each free-space dispersive optical element being an optical grating or an optical prism; and
wherein each free-space dispersive optical element is configured to receive light emitted by a corresponding one of the one or more laser light sources and to route the received light to a corresponding one of the one or more optical detectors; and
wherein the apparatus is configured to adjust the output wavelength of each laser light source based on a light intensity measured by the corresponding optical detector.

22. The apparatus of claim 21, wherein the array of one or more laser light sources includes more than one of the laser light sources, and the apparatus is configured to control each laser light source to output a data-modulated optical carrier in a different wavelength channel than any other of the laser light sources.

23. The apparatus of claim 21, wherein each optical detector is configured to generate an electrical feedback signal that controls an output wavelength of the corresponding laser light source.

24. The apparatus of claim 23, wherein each optical detector includes a first light intensity detector connected to measure light in a first wavelength range and a second light intensity detector connected to measure light in a second wavelength, range, the first and second wavelength ranges being mostly non-overlapping.

25. The apparatus of claim 22, wherein the array of one or more laser light sources includes more than one of the laser light sources, and the apparatus further comprises an optical multiplexer connected to multiplex the data-modulated optical carriers output by the laser light sources.

26. The apparatus of claim 25, wherein each laser light source includes a laser cavity with reflectors at different first and second ends thereof and is connected to transmit light through the first end to the optical multiplexer and transmit light through the second end to the corresponding free-space dispersive optical element.

27. The apparatus of claim 26, wherein each optical detector generates an electrical feedback signal that controls the output wavelength of the corresponding laser light source.

28. The apparatus of claim 26, wherein each optical detector includes a first light intensity detector connected to measure light in a first wavelength range and a second light intensity detector connected to measure light in a second wavelength range, the first and second wavelength ranges being mostly non-overlapping wavelength ranges.

29. The apparatus of claim 22, wherein the apparatus is an optical data transmitter.
